(19) United States
(12) Patent Application Publication
(10) Pub. No.: US 2020/0032972 A1
(43) Pub. Date: Jan. 30, 2020

(54) METHOD AND APPARATUS FOR ILLUMINATING EXTERNAL SURFACE OF AN INFLATABLE STRUCTURE

(71) Applicant: Zachary Wells, Lakeland, FL (US)

(72) Inventor: Zachary Wells, Lakeland, FL (US)

(21) Appl. No.: 16/523,988

(22) Filed: Jul. 26, 2019

Related U.S. Application Data
(60) Provisional application No. 62/703,977, filed on Jul. 27, 2018.

(51) Int. Cl. F21S 4/26; A63G 21/18; A63G 31/12; F21V 21/08; F21V 31/00

(52) U.S. Cl. CPC F21S 4/26; A63G 21/18; F21Y 2115/10; F21V 21/0832; F21V 31/005; A63G 31/12

(57) ABSTRACT

A lighting assembly is provided for an inflatable structure with hook and loop fasteners disposed along an external surface of the inflatable structure. The lighting assembly includes a strip of light emitting diodes (LEDs), a backing including hook and loop fasteners and a layer of transparent material to secure the strip of LEDs to the backing. The hook and loop fasteners of the backing are configured to be attached to the hook and loop fasteners along the external surface of the inflatable structure. The LEDs of the strip are configured to illuminate the external surface of the inflatable structure upon receiving electrical power. A method is also provided for illuminating the external surface of the inflatable structure.

### CROSS REFERENCE TO RELATED APPLICATIONS

This application is a Non-Provisional Application which claims benefit of Provisional Appln. No. 62/703,977, filed Jul. 27, 2018, the entire contents of which are hereby incorporated by reference as if fully set forth herein, under 35 U.S.C. § 119(e).

### BACKGROUND

Outdoor inflatable structures, such as inflatable slides and bounce houses are typically used during daylight hours when adequate sunlight is available and thus users of the inflatable structure can easily see their surroundings. During nighttime or evening hours when adequate sunlight is not available, access to outdoor inflatable structures is usually restricted or denied in order to ensure the safety of the users.

### SUMMARY

The inventor of the present invention recognized that conventional outdoor inflatable structures restrict access to users during nighttime or evening hours due to limited lighting. The inventor of the present invention also recognized that conventional lighting sources (e.g. street lights, etc.) do not adequately illuminate the external surface of the inflatable structure since many external surfaces inherently block the line of sight from such conventional lighting sources. For example, interior walls of a slide portion of the inflatable slide inherently block light from such lighting sources and thus the slide portion of the inflatable slide remains not adequately illuminated. This introduces inherent safety risk when users such as young children slide along this region at a fast speed which is not adequately illuminated. Additionally, the inventor noticed that conventional bounce houses do not feature a light source to illuminate the interior of the bounce house with an external surface of the bounce house where young children engage during use of the bounce house. The inventor of the present invention developed the apparatus and method described herein which provides a lighting assembly that adequately illuminates the external surface of the inflatable structures, including the slide portion of an inflatable slide.

Additionally, the inventor of the present invention recognized that conventional lighting sources used in conjunction with inflatable water slides introduce an inherent safety risk since they position an electrical source in close proximity to water. The inventor of the present invention developed the apparatus and method described herein which features waterproof connections and also permits the power source to be positioned remote from the inflatable water slide, to eliminate these inherent risks of conventional lighting sources.

In a first set of embodiments, a lighting assembly is provided for an inflatable structure with one or more substrates including first hook and loop fasteners disposed along an external surface of the inflatable structure. The lighting assembly includes a strip of light emitting diodes (LEDs), a backing including second hook and loop fasteners and a layer of transparent material to secure the strip of LEDs to the backing. The second hook and loop fasteners of the backing are configured to be attached to the first hook and loop fasteners of the substrate of the inflatable structure. The LEDs of the strip are configured to illuminate the external surface of the inflatable structure upon receiving electrical power.

In a second set of embodiments, a method is provided for illuminating an external surface of an inflatable structure. The method includes providing a lighting assembly including a strip of light emitting diodes (LEDs) secured to a backing including second hook and loop fasteners with a layer of transparent material. The method further includes attaching the second hook and loop fasteners of the backing to first hook and loop fasteners of a substrate along an external surface of the inflatable structure. The method further includes providing electrical power to the strip of LEDs to illuminate the external surface of the inflatable structure.

Still other aspects, features, and advantages are readily apparent from the following detailed description, simply by illustrating a number of particular embodiments and implementations, including the best mode contemplated for carrying out the invention. Other embodiments are also capable of other and different features and advantages, and their several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1A is an image that illustrates an example of a front perspective view of a conventional inflatable slide;

FIG. 1B is an image that illustrates an example of a front perspective view of a conventional inflatable slide;

FIG. 2A is an image that illustrates an example of a top view of components of an unassembled lighting assembly for an inflatable structure, according to an embodiment;

FIG. 2B is an image that illustrates an example of a top view of an assembled lighting assembly for an inflatable structure, according to an embodiment;

FIG. 2C is an image that illustrates an example of a side view of the assembled lighting assembly of FIG. 2B;

FIG. 2D is a schematic diagram that illustrates an example of a side view of a lighting assembly for a structure, according to an embodiment;

FIG. 2E is a schematic diagram that illustrates an example of a top view of the lighting assembly of FIG. 2D;

FIG. 2F is a schematic diagram that illustrates an image that illustrates an example of a cross-sectional view of the lighting assembly of FIG. 2D taken along line 2F-2F;

FIG. 2G is an image that illustrates an example of a perspective view of the assembled lighting assembly of FIG. 2B, according to an embodiment;

FIGS. 3A-3B are images that illustrate an example of a junction of a liner and interior wall of the inflatable slide of FIG. 1B;

FIG. 3C is a schematic diagram that illustrates an example of the liner and interior wall of FIG. 3B detached from each other;

FIG. 3D is a schematic diagram that illustrates an example of the liner and interior wall of FIG. 3B attached to each other;

FIG. 3E is an image that illustrates an example of the assembled lighting assembly attached along the junction of FIG. 3B;

FIG. 4A is an image that illustrates an example of a top view of a control panel of a lighting assembly, according to an embodiment;

FIG. 4B is an image that illustrates an example of a top view of a waterproof extension cord to connect the control panel of FIG. 4A to a power source or strip of LEDs, according to an embodiment;

FIG. 4C is an image that illustrates an example of a top view of the control panel of FIG. 4A connected to the strip of LEDs using the waterproof extension cord of FIG. 4B, according to an embodiment;

FIG. 4D is an image that illustrates an example of a top view of a controller, a remote control panel, a power source and extension cords of a lighting assembly, according to an embodiment;

FIG. 4E is an image that illustrates an example of a perspective view of a T-junction to be used in connecting the extension cords and lighting assembly of FIG. 4D, according to an embodiment;

FIG. 4F is an image that illustrates an example of a top view of a remote control panel of FIG. 4D, according to an embodiment;

FIG. 5A is an image that illustrates an example of a front perspective view of the inflatable slide of FIG. 1B with the lighting assembly attached along the interior walls to illuminate the slide portion, according to an embodiment;

FIG. 5B is an image that illustrates an example of a longitudinal view of the lighting assembly attached along the interior walls of the slide portion of FIG. 5A, according to an embodiment;

FIG. 5C is an image that illustrates an example of a front perspective view of an inflatable structure with the lighting assembly attached along an external surface of the inflatable structure to illuminate the external surface, according to an embodiment;

FIG. 6A is a flow chart that illustrates an example method for illuminating an external surface of an inflatable structure, according to an embodiment; and

FIG. 6B is a flow chart that illustrates an example method for forming a lighting assembly for illuminating an inflatable structure, according to an embodiment.

FIG. 7A is an image that illustrates an example of a top perspective view of an attachment to secure hook and loop fasteners along an external surface of an inflatable structure, according to an embodiment;

FIG. 7B is an image that illustrates an example of a bottom perspective view of the attachment of FIG. 7A secured around an external surface of an inflatable structure, according to an embodiment;

FIG. 7C is an image that illustrates an example of a plan view of a buckle and latch fastener at opposite ends of connecting strips of the attachment of FIG. 7A, according to an embodiment; and

FIG. 7D is an image that illustrates an example of a bottom perspective view of the attachment of FIG. 7B with the lighting assembly secured therewith to illuminate the external surface of the inflatable structure, according to an embodiment.

### DETAILED DESCRIPTION

A method and apparatus are described for illuminating an external surface of an inflatable structure. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5× to 2×, for example, about 100 implies a value in a range from 50 to 200. Moreover, all ranges disclosed herein are to be understood to encompass any and all sub-ranges subsumed therein. For example, a range of “less than 10” for a positive only parameter can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of an inflatable structure including an inflatable slide or other inflatable structure (e.g. bounce houses). In some embodiments, “inflatable structure” means any structure defined by an inflatable surface that is used for recreational purposes (e.g. playing, water sports, etc.). In other embodiments, “inflatable structure” means any structure defined by an inflatable surface with one or more pre-existing substrates that feature hook and loop fasteners (e.g. Velcro®) and/or that is capable of having hook and loop fasteners (e.g. Velcro®) detachably secured around an external surface thereof with an attachment and/or any connective layer that can be used to detachably secure another connective layer (e.g. with hook and loop fasteners such as a buckle and latch fastener). In still other embodiments, “inflatable structure” means any structure defined by an inflatable surface where one or more substrates with hook and loop fasteners are or can be secured or attached to an external surface of the structure during or after manufacturing of the structure. In an embodiment, during the assembly or use of the inflatable structure, a strip of hook and loop fasteners of a component of the inflatable structure (e.g. a liner) is affixed to the hook and loop fasteners of the substrate, to adhere the component to the substrate. In an example embodiment, a width of the substrate is less than a width of the strip of hook and loop fasteners so that an excess width of hook and loop fasteners on the substrate is exposed. In other embodiments, the invention is described in the context of any structure (e.g. inflatable or non-inflatable) that features one or more substrates (e.g. provided during or after manufacturing of the structure) with hook and loop fasteners. Thus, in some embodiments, the invention is directed to any non-inflatable structure with one or more substrates featuring hook and loop fasteners. In other embodiments, the invention is described in the context of any structure that includes a connective layer to which another connective layer can be detachably secured. In some embodiments, the invention is directed to a method for illuminating an external surface of the inflatable structure, where “external surface” means a surface of the inflatable structure that is engaged by a user and/or visible to a user during use of the inflatable structure. In some embodiments, the external surface of the inflatable structure is visible from an exterior of the inflatable structure (e.g. side walls of a slide portion of an inflatable slide). In other embodiments, some portions of the external surface of the inflatable structure is not visible from an exterior of the inflatable structure (e.g. interior of a bounce house where users engage the bounce house).

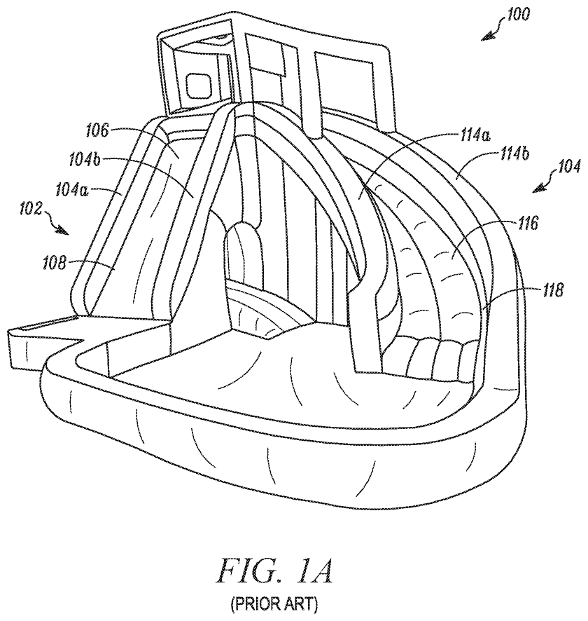

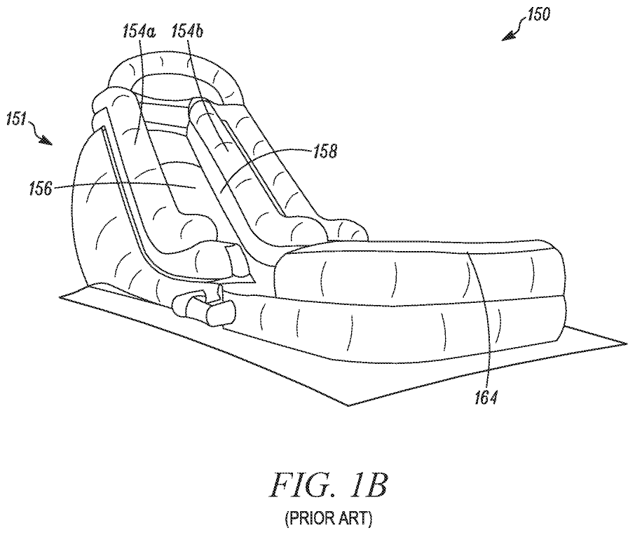

FIG. 1A is an image that illustrates an example of a front perspective view of a conventional inflatable slide 100. A first slide portion 102 includes a pair of side walls 104a, 104b and a liner 106 that is attached to an interior of the side walls 104a, 104b at a junction 108. Hook and loop fasteners (e.g. Velcro®) at a base of the interior side walls 104a, 104b removably attaches to hoop and loop fasteners (e.g. Velcro®) along a side of the liner 106 at the junction 108. Similarly, the slide 100 includes a second slide portion 104 that includes a pair of side walls 114a, 114b and a liner 116 that is attached to an interior of the side walls 114a, 114b at a junction 118. Hook and loop fasteners (e.g. Velcro®) at a base of the interior side walls 114a, 114b removably attaches to hook and loop fasteners (e.g. Velcro®) along a side of the liner 116 at the junction 118. FIG. 1B is an image that illustrates an example of a front perspective view of a conventional inflatable slide 150. A slide portion 151 includes a pair of side walls 154a, 154b and a liner 156 that is attached to an interior of the side walls 154a, 154b at a junction 158.

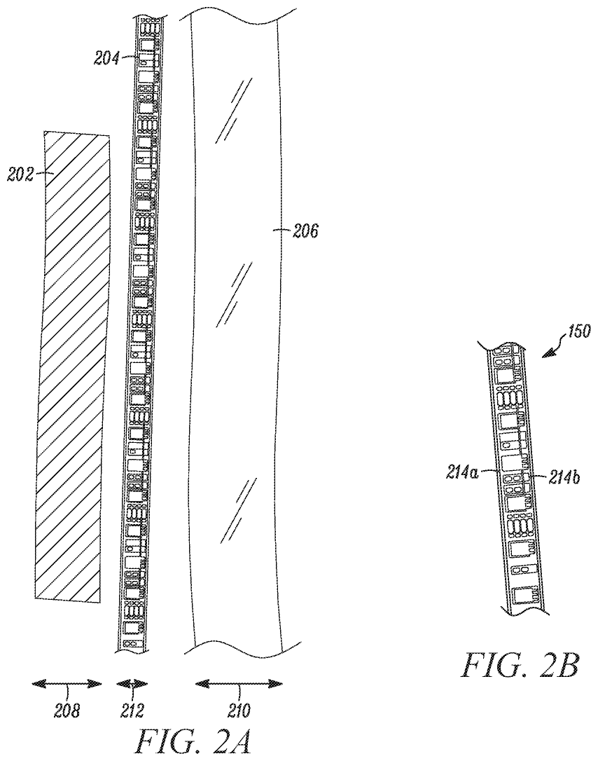

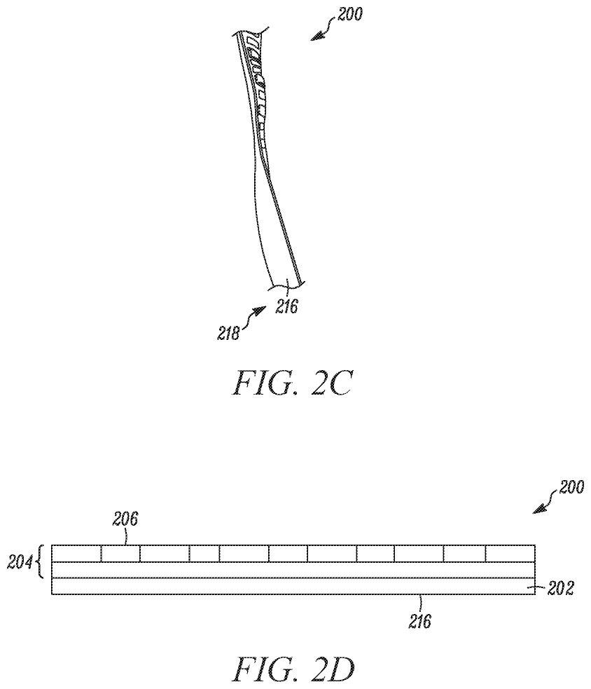

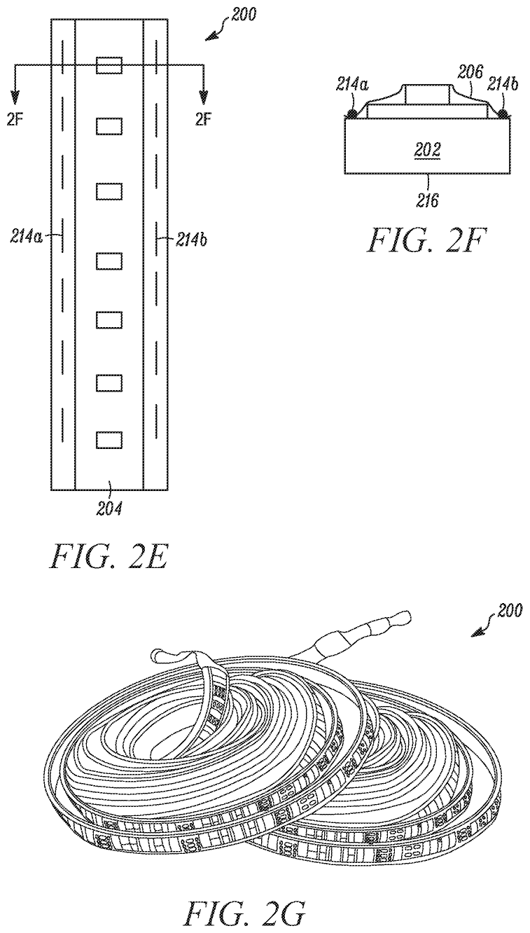

FIGS. 2A-2C and 2G are images that illustrates an example of views of a lighting assembly 200 for an inflatable structure, according to an embodiment. Additionally, FIGS. 2D-2F are schematic diagrams that illustrate an example of views of the lighting assembly 200. In an embodiment, the assembly 200 includes a strip of lighting elements such as a strip of light emitting diodes (LEDs) 204. In some embodiments, the strip of lighting elements is a strip of lighting elements other than LEDs. In another embodiment, the assembly 200 includes a backing 202 with a front side on which the strip of LEDs 204 are positioned and a reverse side 218 opposite to the front side that features hook and loop fasteners 216 (e.g. Velcro®). In other embodiments, the backing 202 is double-sided tape with a first side that is adhered to the strip of LEDs 104 and a second side that can be adhered to the external surface of the structure. Additionally, in one embodiment, the assembly 200 includes a layer of transparent material 206. For purposes of this description, “transparent material” means any material that is capable of transmitting light from the strip of LEDs in the human visible spectrum (e.g. a wavelength of about 400 nanometers or nm to about 700 nm). In one embodiment, the layer of transparent material 206 is a layer of clear vinyl material or a layer of white vinyl material. In another embodiment, the transparent material comprises polyvinyl chloride (PVC). In other embodiments, any transparent material can be used to form the layer of transparent material 206 including plastic, rubber, clear rubber.

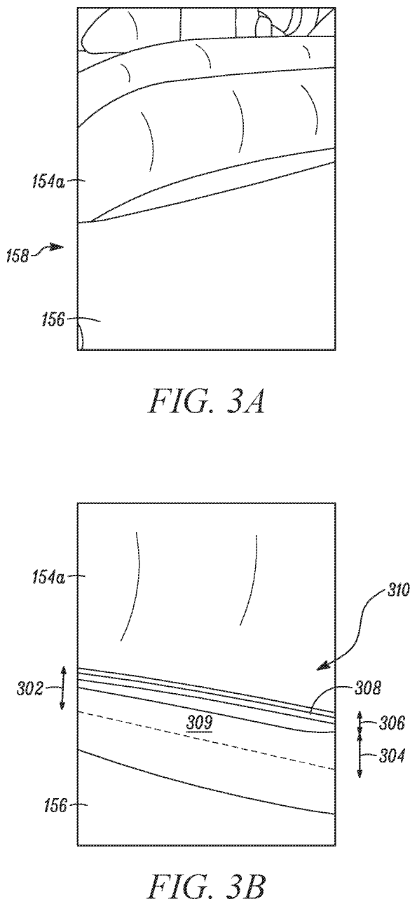

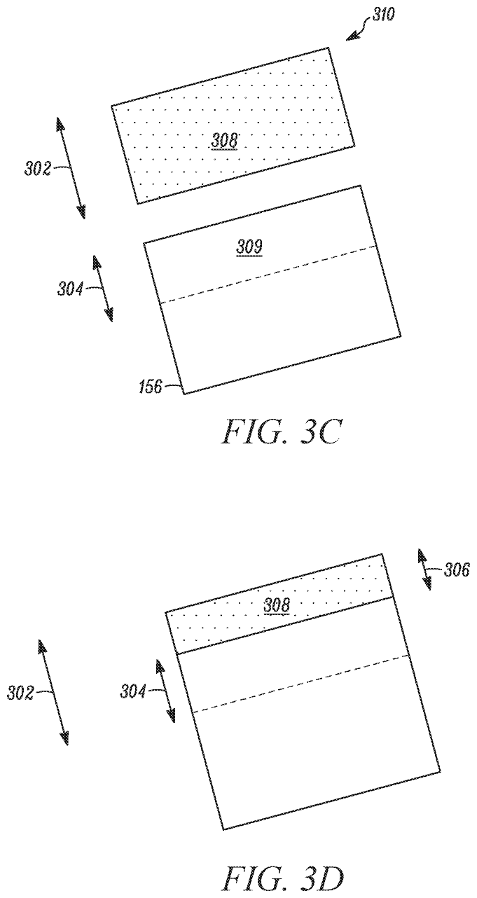

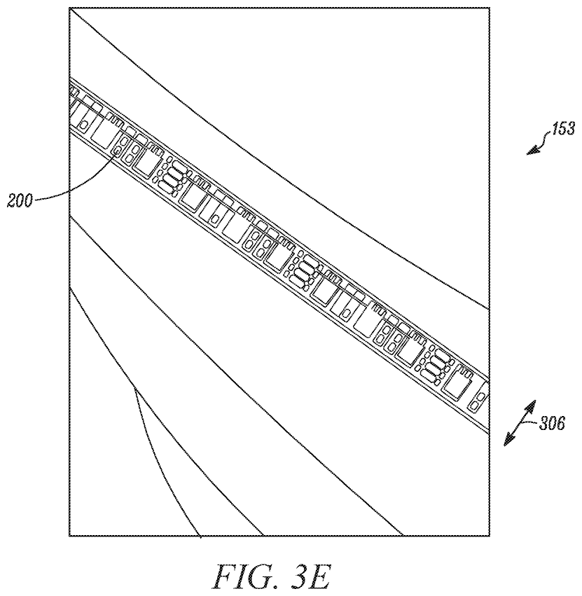

In an embodiment, a width 212 of the strip of LEDs 204 is less than a width 208 of the backing 202 and is also less than a width 210 of the layer of transparent material 206. In another embodiment, the width 208 of the backing 202 is about equal to the width 210 of the layer of transparent material 206. For purposes of this description, “about equal” means that the values are within ±20% of each other. In an example embodiment, the widths 208, 210 are about ½″ or in a range from about ¼″ to about 1″. In an example embodiment, the width 212 is about ⅛″ or in a range from about 1/32″ to about ½″. In some embodiments, a length of the assembly 200 including a length of the strip of LEDs 204, a length of the backing 202 and a length of the layer of transparent material 206 is based on a length of a substrate with hook and loop fasteners along an external surface of an inflatable structure. In an example embodiment, the length of the assembly 200 is based on a length of the substrate 310 (FIG. 3B) with hook and loop fasteners 308 along the external surface of the inflatable slide 150. In one example embodiment, the length of the substrate 310 is about equal to a length of the slide portion 151 of the inflatable slide 150. In an example embodiment, the length of the assembly 200 is made in one or more length increments (e.g. 4 feet, 8 feet, 16 feet) and one or more length increments of the assembly 200 are electrically connected along a length of the substrate 310. In one example embodiment, where the length of the substrate 310 is 20 feet, a first assembly 200 with a length of 4 feet is electrically connected with a second assembly 200 with a length of 16 feet along the length of the substrate 310.

In one embodiment, the strip of LEDs 204 is a strip of LEDs manufactured by Supernight® with one or more parameters including an input voltage of about 12 volts (V) direct current (DC) and about 12 watts (W) per meter (m); a 300 piece 5050 SMD LED chip; a life span of about 50,000 hours; a power requirement of about 60 watts per roll per 5 meters; red/green/blue/white colors; a beam angle of about 120 degrees; a waterproof rating of IP65 and dimensions of about 5000 mm (5m) length, about 10 mm width and about 8 mm thickness. In another embodiment, one or more variables of the strip of LEDs 204 include water resistance, color, adhesives, choice of surface mounted device (SMD), driving voltage, and whether the strip 204 is constant current or constant voltage layout. In another embodiment, the strip 204 is covered in a heat conducting epoxy or silicone to protect the circuitry from direct contact with water, and can be rated IP65, IP67, or with suitable sealed connections IP68. In an example embodiment, the strip 204 has a two sided adhesive backing to stick to the backing 202 or a surface of a structure or inflatable structure (e.g. walls, desks, doors, inflatable slide, etc.). In one embodiment, the LEDs of the strip 204 are multicolor, non-addressable such that each LED is capable of displaying red, green, blue, or all three (white), driven by three input power rails (e.g. three of the four prongs at outlet 402). In one example embodiment, all of the LEDs display the same color at any one time, but the color can be manipulated by varying the voltage applied to each of the three power inputs (e.g. three of the four prongs at outlet 402). In an example embodiment, a strip 204 uses LEDs that contain up to 5 colors in a single LED, such that red, green, blue, warm white and/or cool white can be achieved from a single strip 204. In an embodiment, LED strip 204 designs are available in different types of SMD, such as 3528, single color, non-addressable, very low power; 5050, containing three LEDs allowing for RGB (red green blue) and addressable strips as well as higher power levels; 2835, a newer single-color SMD having the same surface dimensions as the 3528 but a larger emitter area and a thinner design with an integrated heatsink allowing for higher power levels; 5630/5730, a newer replacement for single-color 5050 SMDs which can operate at slightly higher power levels and have high efficacy. In another embodiment, less common designs for the strip 204 include 3014, 4014, 7020, 8020, or other SMDs. In an example embodiment, the LED strip 204 operates on 12 or 24 volts of direct current from a power supply.

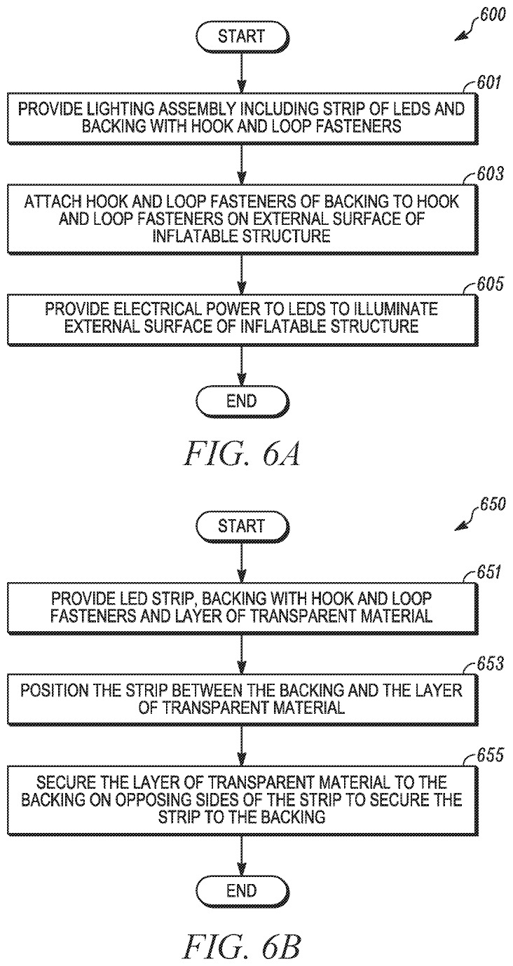

FIG. 6B is a flow chart that illustrates an example method 650 for forming the lighting assembly 200 for illuminating an inflatable structure, according to an embodiment. In an embodiment, the method 650 includes an initial step of providing 651 the strip of LEDs 204, the backing 202 and the layer of transparent material 206. In an embodiment, the method 650 also includes positioning 653 the strip of LEDs 204 between the backing 202 and the layer of transparent material 206. In some embodiments, step 653 includes positioning the strip of LEDs 204 on the front side of the backing 202 that is opposite from the reverse side 218 with the hook and loop fasteners 216. In an example embodiment, the positioning 653 step includes centering the strip of LEDs 204 on the front side of the backing 202. In another embodiment, step 653 further includes positioning the layer of transparent material 206 over the strip of LEDs 204 (e.g. covering the strip of LEDs 204) after the strip of LEDs 204 are positioned on the front side of the backing 202. In an example embodiment, after step 653 the strip of LEDs 204, the backing 202 and the layer of transparent material 206 are aligned and parallel to each other and the widths 208, 210, 212 overlap.

In an embodiment, after step 653 the strip of LEDs 204 is positioned on the front side of the backing 202, the method 650 then includes the step of securing 655 the layer of transparent material 206 to the backing 202 to secure the strip of LEDs 204 to the backing 202. In an embodiment, in step 655 the layer of transparent material 206 is secured to backing 202 on opposing sides of the strip of LEDs 204 after centering the strip of LEDs 204 on the front side of the backing 202 in step 653. In one embodiment, in step 655 the securing step involves sewing or stitching the layer of transparent material 206 to the backing 202 on the opposing sides of the strip of LEDs 204 and forming threads 214a, 214b on opposing sides of the strip of LEDs 204. In one embodiment, the threads 214a, 214b are formed with a linear density in a range from about 5 stitches per inch to about 20 stitches per inch. In an embodiment, the formed threads 214a, 214b are aligned about parallel with an edge of the backing 202 and/or with the strip of LEDs 204. In some embodiments, between step 653 and 655, the strip of LEDs 204 is adhered to the backing 202 using an adhesive (e.g. an adhesive provided on a back surface of the strip of LEDs 204). Although the method 650 discusses using the layer of transparent material 206 to secure the strip of LEDs 204 to the backing 202, in other embodiments the strip of LEDs 204 is secured to the backing 202 without the layer of transparent material 206 and thus in these embodiments the lighting assembly need not include the layer of transparent material 206. In one of these embodiments, the strip of LEDs 204 is directly adhered to the backing 202 using a glue or adhesive.

FIGS. 3A-3B are images that illustrate an example of the junction 158 of the liner 156 and interior wall 154a of the inflatable slide 150 of FIG. 1B. The interior wall 154a includes a substrate 310 with hook and loop fasteners 308 (e.g. Velcro®) and having a width 302. The liner 156 has a reverse side (not shown) with a strip of hook and loop fasteners 309 (e.g. Velcro®) having a width 304 that is less than the width 302. To secure the liner 156 to the interior wall 154a, the strip of hook and loop fasteners 309 are attached to the hook and loop fasteners 308 of the substrate 310, which leaves an exposed width 306 of the hook and loop fasteners 308 of the substrate 310. In one example embodiment, the width 302 is about 3″ or in a range from about 2″ to about 4″, the width 304 is about 1.5″ or in a range from about 1″ to about 2″ and the exposed width 306 is about ¾″ or in a range from about ½″ to about 1″. FIG. 3C is a block diagram that illustrates an example of the liner 156 and interior wall 154a of FIG. 3B detached from each other. FIG. 3D is a block diagram that illustrates an example of the liner 156 and interior wall 154a of FIG. 3B attached to each other.

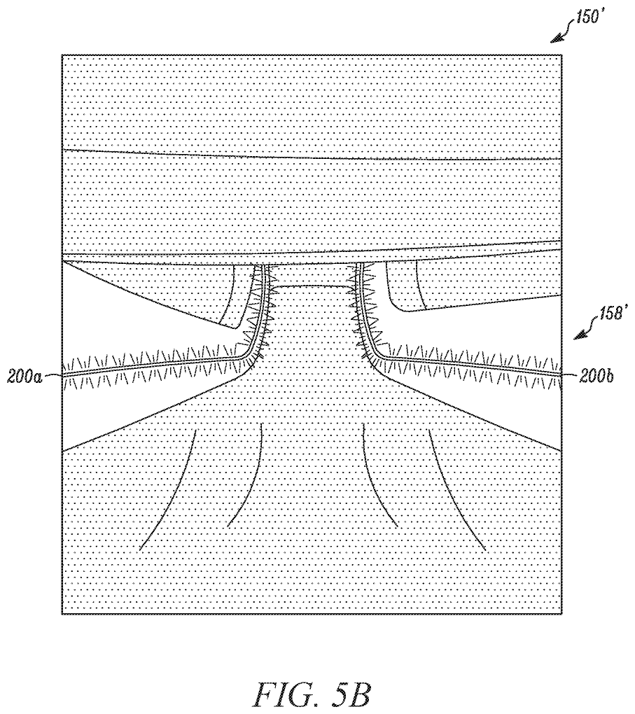

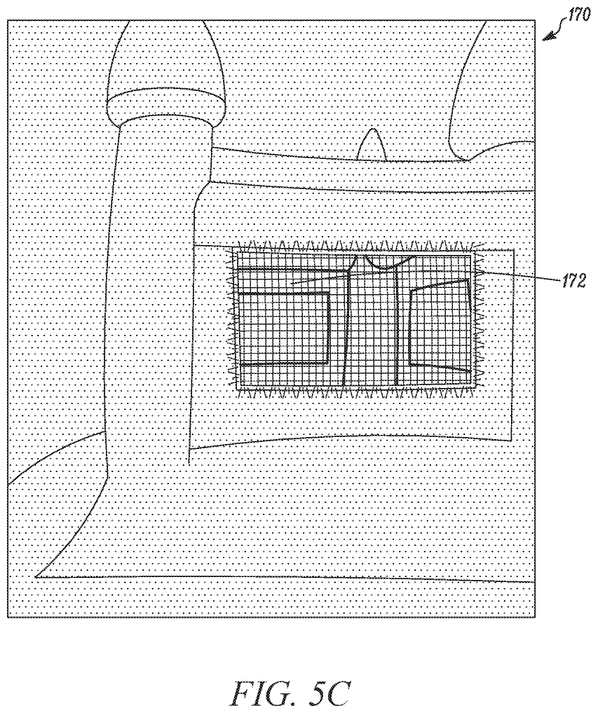

FIG. 3E is an image that illustrates an example of the lighting assembly 200 attached along the junction 158 of FIG. 3B. In an embodiment, the lighting assembly 200 is secured along the substrate 310 with the hook and loop fasteners 308. In one embodiment, the hook and loop fasteners 216 on the reverse side 218 of the backing 208 are attached along the exposed width 306 of the hook and loop fasteners 308. In an example embodiment, the width 208, 210 of the lighting assembly 200 is sized based on the width 302 and the width 304. In a further example embodiment, the width 208, 210 of the lighting assembly 200 is sized to be less than or equal to the exposed width 306 so that the lighting assembly 200 can be attached along the exposed width 306 of the substrate 308. For purposes of this description, “less than or equal to” means less than or within 20%. As depicted in FIG. 1B, the liner 156 is attached to each interior wall 154a, 154b at a respective junction 158 and in some embodiments a pair of lighting assemblies 200a, 200b are provided and are secured along an exposed width 306 of the substrate 308 at each respective junction 158 on each interior wall 154a, 154b. The second lighting assembly is secured to the substrate on the opposing interior wall in a similar manner as the lighting assembly 200 discussed above. Although FIGS. 3A-3E depict a substrate 310 with hook and loop fasteners 308 along the interior walls 154 of the slide portion 151, the invention is not limited to attaching a lighting assembly 200 to this substrate 310 and includes attaching the lighting assembly 200 to a substrate with hook and loop fasteners along any portion of the external surface of the inflatable slide 150, such as a palm tree 160, an arch 162 and/or any portion of a pool (e.g. perimeter wall 164) where a user enters after sliding down the slide portion 151, as depicted in FIG. 5A.

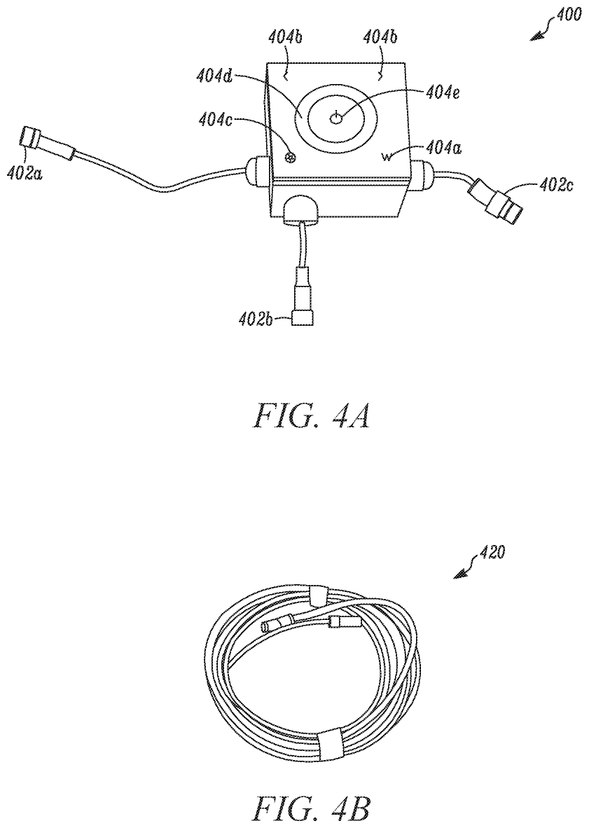

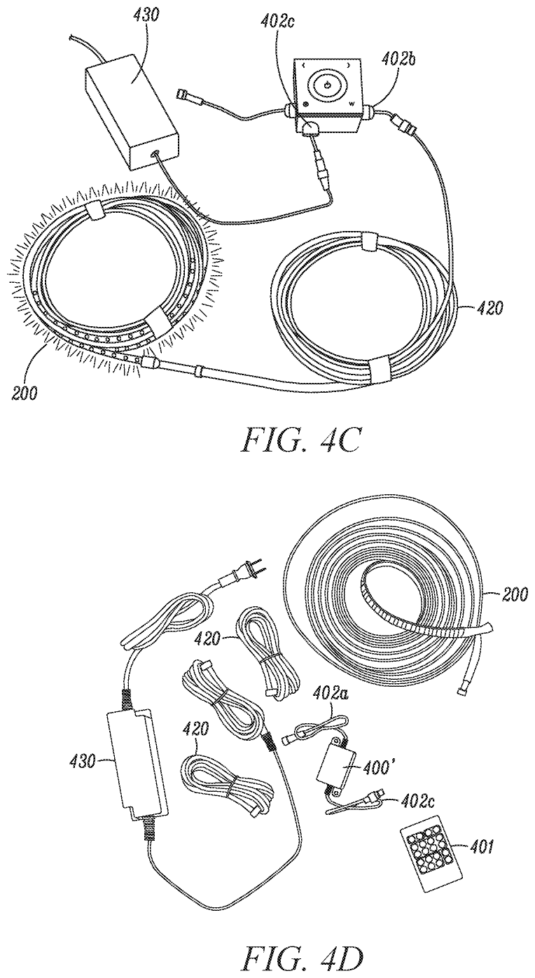

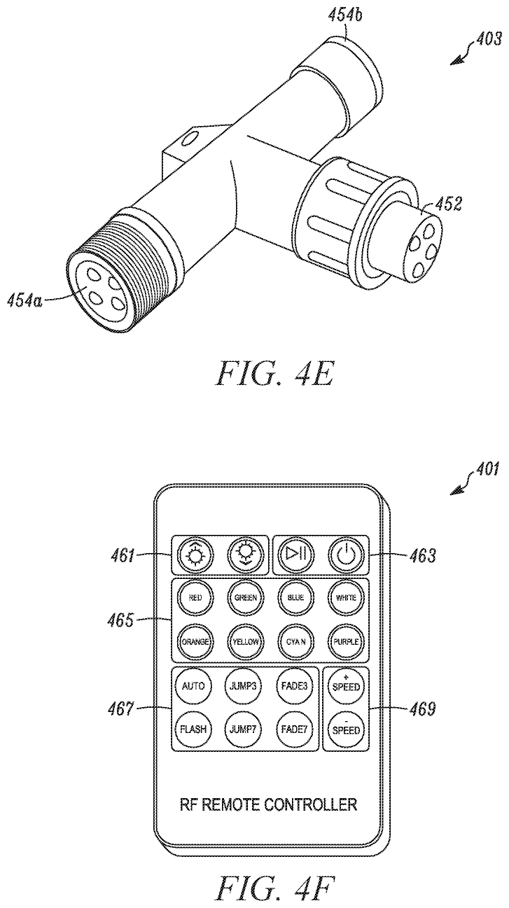

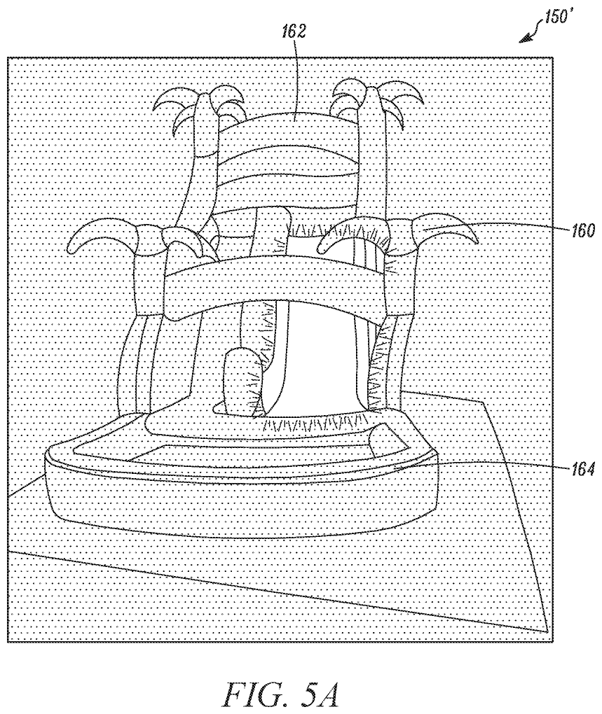

FIG. 4A is an image that illustrates an example of a top view of a control panel 400 of a lighting assembly 200, according to an embodiment. FIG. 4B is an image that illustrates an example of a top view of a waterproof extension cord 420 to connect the control panel 400 of FIG. 4A to a power source 430 or lighting assembly 200, according to an embodiment. FIG. 4C is an image that illustrates an example of a top view of the control panel 400 of FIG. 4A connected to the lighting assembly 200 using the waterproof extension cord 420 of FIG. 4B, according to an embodiment. In an embodiment, the control panel 400 is used to connect the power source 430 to the lighting assembly 200 using one or more waterproof connections. In an embodiment, the power source 430 is a waterproof power source such as a Lighting Wil® Waterproof power supply. In an example embodiment, the waterproof power source is a Lighting Will® Waterproof IP67 LED Power Supply Driver Transformer with an input of 90-265 V, 0.7 A A/C and 50/60 Hz and an output of 12 V DC, 8.5 A and 100 watts; and which converts 110 V AC to 12 V DC. In one embodiment, a waterproof connection is provided between the control panel 400 and the power source 430. In an example embodiment, the waterproof connection includes a waterproof inlet 402c on the control panel 400 and a waterproof extension cord 420 to connect the power source 430 to the waterproof inlet 402c. In an example embodiment, the waterproof inlet 402c is a 2-prong waterproof connector. In one embodiment, a waterproof connection is provided between the control panel 400 and the lighting assembly 200. In an example embodiment, the waterproof connection includes one or more waterproof outlets 402a, 402b on the control panel 400 and one or more waterproof extension cords 420 to connect one or more lighting assemblies 200a, 200b to the waterproof outlets 402a, 402b. In an example embodiment, the waterproof outlets 402a, 402b are 4 prong waterproof connectors (e.g. where the cords 420 and/or outlets 402 have a diameter of about ¼″ or about ½″). In an example embodiment, the control panel 400 includes a DX4 RGBW Touch Panel Manual LTECH® LED controller. A waterproof extension cord 420 need not be used for every waterproof connection and in some embodiments, a waterproof cord (e.g. non-extension) is used. FIG. 4D illustrates a similar embodiment as the embodiment of FIG. 4C, with the exception that it features a remote control panel 401 that is in wireless communication with a controller 400′ that is connected between the power source 430 and the lighting assembly 200, in a similar manner as the control panel 400 n FIG. 4C. In some embodiments, the controller 400′ features the waterproof inlet 402c (e.g. to connect with the power source 430) and one waterproof outlet 402a. In an embodiment, the waterproof outlet 402a is used to connect with a single lighting assembly 200. In another embodiment, a T-junction 403 (FIG. 4E) is used to connect the waterproof outlet 402a to two lighting assemblies 200. In this embodiment, the inlet 452 to the T-junction 403 is connected to the waterproof outlet 402a and the two outlets 454a, 454b are coupled to the two lighting assemblies 200. In an example embodiment, the controller 400′ features two waterproof outlets 402a, 402b and two T-junctions 403 can be employed so that the single controller 400′ can power four light assemblies 200. In an example embodiment, such an arrangement may use a booster back between the power source 430 and the controller 400′ to ensure that sufficient power is provided to power the four light assemblies 200. Thus, the embodiment of FIG. 4D advantageously eliminates the need for a user to manually use the control panel 400 to adjust one or more operating parameters of the lighting assembly 200 and instead the user can press one or more buttons on the remove control panel 401 which in turns transmits one or more signals to the controller 400′ which causes the same result as if the user were to manually adjust the control panel 400 of FIG. 4C.

The waterproof connections advantageously provide safety when the lighting assembly 200 is used in conjunction with an inflatable structure that employs water (e.g. inflatable water slide). A length of the extension cord 420 advantageously permits the power source 430 and/or control panel 400 and/or controller 400′ to be positioned remote from an inflatable structure employing water (e.g. inflatable water slide). In one embodiment, where the extension cord 420 connects the lighting assembly 200 to the control panel 400 or controller 400′, the control panel 400 or controller 400′ and the power source 430 can be remotely positioned from the inflatable structure based on the length of the extension cord 420. In another embodiment, where the extension cord 420 connects the power source 430 to the control panel 400 or controller 400′, the power source 430 can be remotely positioned from the inflatable structure based on the length of the extension cord 420. In one example embodiment, the length of the extension cord 420 is adjustable from about 1′ to about 100′, based on the arrangement of the extension cord 420. In this example embodiment, when the length of the extension cord 420 is desired to be a shorter length, only a portion of a maximum length of the extension cord 420 is unwound whereas when the length of the extension cord 420 is desired to be a longer length, a greater portion of the maximum length of the extension cord 420 is unwound. In an example embodiment, the shorter length of the extension cord 420 is used when attaching the lighting assemblies 200 to inflatable structures where no water is used (e.g. bounce house) whereas a longer length of the extension cord 420 is used when attaching the lighting assemblies 200 to inflatable structures where water is used (e.g. inflatable water slides). In yet another example embodiment, the length of the extension cord 420 is adjustable from about 1′ to about 200′.

In another embodiment, the control panel 400 features one or more regions 404 that can be adjusted or selected to adjust a value of one or more parameters of light emitted from the strip of LEDs 204 of the lighting assembly 200. In one embodiment, the control panel 400 includes a color region 404d that can be selected to adjust a color of the light emitted from the strip of LEDs 204. In an example embodiment, the color region 404d is a circle with different colors around the circle and the user selects a desired color by touching the desired color on the perimeter of the circle. In another embodiment, the control panel 400 includes a mode region 404c that can be selected to adjust a mode of the light emitted from the strip of LEDs 204. In another embodiment, the control panel 400 includes a white light region 404a that can be selected to turn the color of light emitted from the strip of LEDs 204 to white. In one example embodiment, the modes include one or more of a flashing mode (e.g. where the LEDs flash), a static mode (e.g. where the LEDs remain on) and a rotation mode between a plurality of colors. In an example embodiment, the modes rotate as the user selects or touches the mode region 404c. In another embodiment, the control panel 400 includes an intensity region 404b that can be selected to adjust an intensity of the light emitted from the strip of LEDs 204. In an example embodiment, the intensity region 404b includes two regions where a first region (e.g. arrow in a first direction) increases an intensity of the light when it is selected and a second region (e.g. arrow in a second direction opposite to the first direction) decreases an intensity of the light when it is selected. In another embodiment, the control panel 400 includes a power region 404e that can be selected to facilitate or interrupt the transmission of electrical power from the power source 430 to the strip of LEDs 204. Selecting or touching the power region 404e a first time transmits electrical power from the power source 430 to the strip of LEDs 204 and illuminates the LEDs 204 whereas selecting or touching the power region 404e a second time interrupts the transmission of electrical power from the power source 430 to the strip of LEDs 204 and causes the strip of LEDs 204 to turn off.

In another embodiment, the remote control panel 401 features one or more regions that can be adjusted or selected to adjust a value of one or more parameters of light emitted from the strip of LEDs 204 of the lighting assembly 200. In one embodiment, the remote control panel 401 includes a color region 465 that can be selected to adjust a color of the light emitted from the strip of LEDs 204. In an example embodiment, the color region 465 is a plurality of buttons with different colors and the user selects a desired color by touching the button associated with the desired color. In another embodiment, the remote control panel 401 includes a mode region 467 that can be selected to adjust a mode of the light emitted from the strip of LEDs 204. In an example embodiment, the mode region 467 includes a button for auto mode (e.g. cycles the LEDs 204 through the colors); a button for flash mode (e.g. strobes the LEDs 204 in white color); jump 3 (e.g. LEDs 204 cycle through 3 colors such as red green blue or RGB); jump 7 (e.g. LEDs 204 cycle through 7 colors); fade 3 (e.g. LEDs 204 cycle and simultaneously fades the intensity through 3 colors); fade 7 (e.g. LEDs 204 cycle and simultaneously fades the intensity through 7 colors). In another embodiment, the remote control panel 401 includes a speed region 469 with an increase speed button and decrease speed button which respectively increase and decrease the cycling speed for the modes in the mode region 467. In another embodiment, the remote control panel 401 includes an intensity region 461 which includes an intensity up and intensity down button which respectively increase and decrease the intensity of the light from the LEDs 204 during any of the modes. In another embodiment, the remote control panel 401 includes a stop region 463 which includes a play/pause button that can be pressed to pause and recommence the emission of light from the LEDs 204 and a power button that can be pressed to turn the LEDs 204 on or off.

FIG. 5A is an image that illustrates an example of a front perspective view of the inflatable slide 150 of FIG. 1B with the lighting assembly 200 attached along the interior walls 154a, 154b to illuminate the slide portion 151, according to an embodiment. The inflatable slide 150′ of FIG. 5A is distinct from the inflatable slide 150 of FIG. 1B since the inflatable slide 150′ features an installed lighting assembly 200 that has been attached along the external surface of the inflatable slide 150 (e.g. the substrate 310) and has been activated by the control panel 400 or remote control panel 401 and power source 430 to illuminate the external surface of the inflatable slide 150′ (e.g. the slide portion 151). FIG. 5B is an image that illustrates an example of a longitudinal view of the lighting assembly 200a, 200b attached along the interior walls 154a, 154b of the slide portion 151′ of FIG. 5A, according to an embodiment. The slide portion 151′ is distinct from the slide portion 151 of FIG. 1B since the slide portion 151′ features the installed lighting assemblies 200a, 200b that can illuminate the external surface of the slide portion 151′. In an embodiment, the lighting assemblies 200a, 200b are attached along the substrates 310 (e.g. to the exposed width 306 of hook and loop fasteners 308) of the interior walls 154a, 154b. In one example embodiment, the lighting assemblies 200a, 200b are connected to the waterproof inlets 402a, 402b of the control panel 400 or controller 400′ using extension cords 420 so that electrical power is transmitted from the power source 430 to the lighting assemblies 200a, 200b through the control panel 400 or controller 400′. In an example embodiment, the user selected the color red in the color region 404d.

Although FIGS. 5A-5B depict the lighting assembly 200 attached along an external surface of one type of inflatable structure (e.g. an inflatable slide), the embodiments of the invention are not limited to the lighting assembly 200 being attached along an external surface of this type of inflatable structure and includes the lighting assembly 200 being attached along the external surface of other inflatable structures. FIG. 5C is an image that illustrates an example of a front perspective view of an inflatable structure other than inflatable slides (e.g. a bounce house 170) with the lighting assembly 200 attached along an external surface of the inflatable structure to illuminate the external surface, according to an embodiment. In an embodiment, the lighting assembly 200 (not shown) is attached along a ceiling (not shown) and/or at a juncture of the ceiling and a sidewall 172 of the bounce house 170. In one example embodiment, the lighting assembly 200 is attached along hook and loop fasteners of a substrate positioned along the ceiling and/or the juncture of the ceiling and the sidewall 172, in a similar manner as the lighting assembly 200 is attached to the substrate 310 in the inflatable slide 150′.

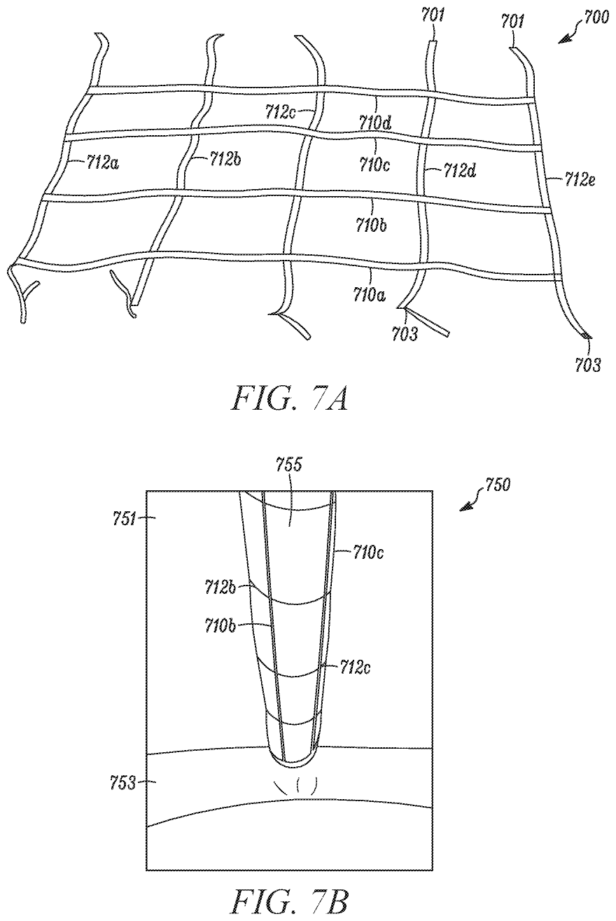

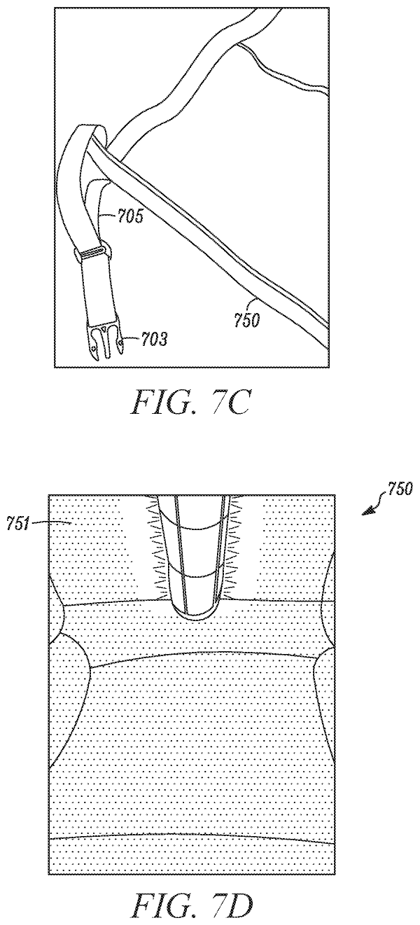

FIG. 7A is an image that illustrates an example of a top perspective view of an attachment 700 to removably attach hook and loop fasteners along an external surface of an inflatable structure, according to an embodiment. In an embodiment, the inflatable structure is the bounce house 170 (FIG. 5C). In another embodiment, the external surface is a surface of the bounce house 170 within an interior of the bounce house 170 that is contacted or engaged by users of the bounce house 170 and/or is visible by users of the bounce house 170.

In an embodiment, the attachment 700 includes a plurality of strips 710a, 710b, 710c, 710d that extend from a first end to a second end (e.g. over a length) of the attachment 700. In one embodiment, one or more of the strips 710a, 710b, 710c, 710d include hook and loop fasteners 760 (FIG. 7C)(e.g. Velcro®) along the strips. In some embodiments, the hook and loop fasteners are only provided over a portion of the length of the strips 710a, 710b, 710c, 710d. In other embodiments, the hook and loop fasteners extend over an entire length (e.g. defined between the first end and second end of the attachment 700) of the strips 710a, 710b, 710c, 710d. In other embodiments, hook and loop fasteners are provided along each of the strips 710a, 710b, 710c, 710d. Although FIG. 7A depicts four strips 710a, 710b, 710c, 710d in the attachment 700, in other embodiments, less or more than four strips are provided in the attachment 700.

In an embodiment, the attachment 700 also includes a plurality of connecting strips 712a, 712b, 712c, 712d, 712e that extend from a first side to a second side (e.g. over a width) of the attachment 700. In some embodiments, the length of the attachment (e.g. between the opposite ends of the strips 710) is greater than the width of the attachment (e.g. between the opposite ends of the connecting strips 712). In an example embodiment, a length of the attachment 700 (e.g. length of the straps 710) is in a range from about 2 feet to about 12 feet and a width of the attachment 700 (e.g. length of the straps 712) is about 3 feet or in a range from about 2 feet to about 4 feet. In an example embodiment, the length of the attachment is adjusted based on a length of a support tube (e.g. center support tube 755) of the bounce house 170 so that the straps 710 can secure along a length (e.g. in a range from about 2 feet to about 12 feet) of the support tube. In another example embodiment, the width of the attachment is adjusted based on a circumference (e.g. about 3 feet) of the support tube (e.g. center support tube 755) of the bounce house 170 so that the straps 712 can wrap around the circumference of the support tube. In one embodiment, the plurality of connecting strips 712a, 712b, 712c, 712d, 712e are oriented at an angle (e.g. about 90 degrees±10 degrees) with respect to the plurality of strips 710a, 710b, 710c, 710d. In another embodiment, one or more of the connecting strips 712a, 712b, 712c, 712d, 712e intersect or attach (e.g. sewn to, attached via adhesive, etc.) to each of the plurality of strips 710a, 710b, 710c, 710d so to connect the strips together. In one embodiment, each of the connecting strips 712a, 712b, 712c, 712d, 712e intersect with each of the plurality of strips 710a, 710b, 710c, 710d, to connect the strips 710 together.

In an embodiment, the attachment 700 also includes hook and loop fasteners at opposite ends of the connecting strips 712a, 712b, 712c, 712d, 712e. In an embodiment, the hook and loop fastener is a buckle and latch fastener 703 with an adjustable strap 705 (FIG. 7C). In an embodiment, a buckle of the fastener 703 is provided at one end of the connecting strip 712 and a latch of the fastener 703 is provided at an opposite end of the connecting strip 712. Although a buckle and latch fastener is depicted in FIGS. 7A-7D, in other embodiments any hook and loop fastener can be employed at opposite ends of the connecting strips 712. In an embodiment, the hook and loop fastener at the opposite ends of the connecting strips 712 is configured to self-attach to secure the attachment 700 around the external surface of the inflatable structure.

FIG. 6A is a flow chart that illustrates an example method 600 for illuminating an external surface of an inflatable structure. Although steps are depicted in FIG. 6A, and in subsequent flowchart of FIG. 6B as integral steps in a particular order for purposes of illustration, in other embodiments, one or more steps, or portions thereof, are performed in a different order, or overlapping in time, in series or in parallel, or are omitted, or one or more additional steps are added, or the method is changed in some combination of ways.

FIG. 6A is a flow chart that illustrates an example method 600 for illuminating an external surface of an inflatable structure, according to an embodiment. In step 601, the lighting assembly 200 is provided including the strip of LEDs 204 and the backing 202 with the hook and loop fasteners 216. In another embodiment, in step 601 the lighting assembly 200 includes the layer of transmission material 206 that secures the strip of LEDs 204 to the backing 202. In one embodiment, step 601 is performed using the method 650.

In an embodiment, in step 603 hook and loop fasteners 216 of the backing 202 are attached to hook and loop fasteners 308 of the substrate 310 on the external surface of the inflatable structure. In one embodiment, in step 603 the hook and loop fasteners 216 are attached to the exposed width 306 of the hook and loop fasteners 308 of the substrate 310. In yet another embodiment, in step 603 the hook and loop fasteners 216 are attached along a length of the hook and loop fasteners 308 of the substrate 310 which extends about a length of the slide portion 151.

In an embodiment, in step 605 electrical power is provided to the strip of LEDs 204 of the lighting assembly 200 to illuminate the external surface of the inflatable structure. In an embodiment, step 605 is performed by providing the waterproof connections between the lighting assembly 200 and the control panel 400 and between the control panel 400 and the power source 430. Additionally, in one embodiment, step 605 is performed by selecting one or more of the regions 404 on the control panel 400, such as the power region 404e.

In one embodiment, the method 600 can be performed for illuminating the external surface of the inflatable structure using the attachment 700 of FIGS. 7A-7D. In step 601, the lighting assembly 200 is provided including the strip of LEDs 204 and the backing 202 with the hook and loop fasteners 216. In another embodiment, in step 601 the lighting assembly 200 includes the layer of transmission material 206 that secures the strip of LEDs 204 to the backing 202. In one embodiment, step 601 is performed using the method 650.

In an embodiment, in step 603 the attachment 700 is secured to the external surface of the inflatable structure. In one embodiment, in the inflatable structure is the bounce house 170. In an embodiment, the bounce house 170 includes a center support tube 755 (FIG. 7B) that extends along a ceiling of the bounce house 170. In this embodiment, the attachment 700 is secured around a perimeter of the external surface of the center support tube 755 by first extending the opposite ends of the connecting strips 712a, 712b, 712c, 712d, 712e around opposite sides of the center support tube 755. In an example embodiment, a length of the connecting strips 712 is sized based on (e.g. about equal) a circumference of the center support tube 755. The hook and loop fastener 703 (e.g. buckle and latch fastener) of the connecting strips 712 are then self-attached, to secure the connecting straps 712 around the center support tube 755 and thus secure the attachment 700 around the perimeter of the external surface of the center support tube 755. The hook and loop fasteners 760 (e.g. Velcro®) as shown in FIG. 7C along the plurality of strips 710a, 710b, 710c, 710d are then exposed and aligned along the external surface of the center support tube 755. In this embodiment, in step 603, one or more strips of LEDs 204 can be attached to the plurality of strips 710a, 710b, 710c, 710d by securing the hook and loop fasteners 216 on the backing 202 of each LED strip with the hook and loop fasteners 760 along the plurality of strips 710a, 710b, 710c, 710d. Step 605 is performed in a similar manner as discussed above. FIG. 7D depicts the interior of the bounce house after the ceiling 751 is illuminated after step 605. This advantageously provides more light during certain conditions (e.g. evening, night, etc.) so to minimize risks associated with use in dark conditions.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article.

What is claimed is:

1. A lighting assembly for an inflatable structure comprising first hook and loop fasteners disposed along an external surface of the inflatable structure, said lighting assembly comprising:
a strip of light emitting diodes (LEDs);
a backing including second hook and loop fasteners; and
a layer of transparent material to secure the strip of LEDs to the backing;
wherein the second hook and loop fasteners of the backing are configured to be attached to the first hook and loop fasteners of the inflatable structure;
and wherein the LEDs of the strip are configured to illuminate the external surface of the inflatable structure upon receiving electrical power.

2. The lighting assembly as recited in claim 1, wherein the transparent material comprises clear vinyl material.

3. The lighting assembly as recited in claim 1, wherein the layer of transparent material is sewn to the backing.

4. The lighting assembly as recited in claim 1, wherein a width of the strip of LEDs is less than a width of the backing and a width of the layer.

5. The lighting assembly as recited in claim 4, wherein the width of the backing is about equal to the width of the layer.

6. The lighting assembly as recited in claim 1, wherein the first hook and loop fasteners along the external surface of the inflatable structure and the second hook and loop fasteners of the backing comprise Velcro®.

7. The lighting assembly as recited in claim 1, wherein the inflatable structure is an inflatable slide and wherein the inflatable slide comprises one or more substrates comprising the first hook and loop fasteners along the external surface of the inflatable slide.

8. The lighting assembly as recited in claim 7,
wherein the substrate along the external surface of the inflatable slide has a first width;
wherein a liner of the inflatable slide comprises a strip of first hook and loop fasteners, wherein the strip has a second width that is less than the first width and wherein the strip is configured to be attached to the substrate of the inflatable slide; and
wherein the backing has a third width that is based on the first width and the second width.

9. The lighting assembly as recited in claim 8, wherein the third width is less than or equal to a difference of the first width and the second width.

10. The lighting assembly as recited in claim 8, wherein the assembly comprises:
a pair of the strips of LEDs;
a pair of the backings; and
a pair of the layers of transparent material wherein each layer of transparent material secures a respective strip of LEDs to a respective backing;
and wherein the liner comprises a pair of strips of third hook and loop fasteners configured to be attached to a pair of substrates along opposing interior walls of the inflatable slide.

11. The lighting assembly as recited in claim 1, further comprising an attachment to removably attach the first hook and loop fasteners along the external surface of the inflatable structure.

12. The lighting assembly as recited in claim 11, wherein said attachment comprises:
a plurality of strips extending from a first end to a second end of the attachment, wherein at least one of the strips comprises the first hook and loop fasteners;
a plurality of connecting strips extending from a first side to a second side, said plurality of connecting strips attached to each of the plurality of strips between the first side and the second side of the attachment; and
third hook and loop fasteners secured to opposite ends of the plurality of connecting strips, said third hook and loop fasteners configured to self-attach to secure the attachment around the external surface of the inflatable structure.

13. The lighting assembly as recited in claim 12, wherein the plurality of connecting strips are oriented about orthogonal to the plurality of strips, wherein each of the strips comprises the first hook and loop fasteners and wherein the third hook and loop fasteners is different than the first hook and loop fasteners of the plurality of strips.

14. The lighting assembly as recited in claim 12, wherein the inflatable structure is a bounce house, wherein the external surface is a center support tube of the bounce house, wherein the first hook and loop fasteners comprise Velcro® and wherein the third hook and loop fasteners comprise a latch and buckle fastener.

15. The lighting assembly as recited in claim 1, further comprising:
a power source;
a control panel;
a first waterproof connection between the control panel and the power source, said first waterproof connection comprising a waterproof inlet on the control panel and a waterproof cord between the waterproof inlet and the power source and
a second waterproof connection between the control panel and the strip of LEDs, said second waterproof connection comprising a waterproof outlet on the control panel and a waterproof cord between the waterproof outlet and the strip of LEDs.

16. The lighting assembly as recited in claim 15, wherein the control panel includes one or more regions configured to be selected to adjust a value of one or more parameters of light emitted from the strip of LEDs and wherein the one or more regions include at least one of:
a color region configured to be selected to adjust a color of the light emitted from the strip of LEDs;
a mode region configured be selected to adjust a mode of the light emitted from the strip of LEDs wherein the mode includes one or more of a flashing mode, a static mode and a rotation mode between a plurality of colors;
an intensity region configured to be selected to adjust an intensity of the light emitted from the strip of LEDs; and
a power region configured to be selected to facilitate or interrupt the transmission of electrical power from the power source to the strip of LEDs.

17. The lighting assembly as recited in claim 15, wherein the inflatable structure is an inflatable water slide and wherein the waterproof cords comprise at least one waterproof extension cord having a length of at least 50′ so that the power source can be separated from the inflatable water slide by at least 50′.

18. A method for illuminating an external surface of an inflatable structure, comprising:
providing a lighting assembly comprising a strip of light emitting diodes (LEDs) secured to a backing including second hook and loop fasteners with a layer of transparent material;
attaching the second hook and loop fasteners of the backing to first hook and loop fasteners along an external surface of the inflatable structure; and
providing electrical power to the strip of LEDs to illuminate the external surface of the inflatable structure.

19. A method as recited in claim 18, wherein the attaching step comprises attaching the second hook and loop fasteners of the backing to the first hook and loop fasteners of a substrate along the external surface of the inflatable structure, wherein a width of the backing is less than a width of the substrate such that the attaching step comprises attaching the second hook and loop fasteners of the backing over a portion of the width of the substrate that is less than the width of the substrate.

20. A method as recited in claim 18, further comprising attaching the first hook and loop fasteners, with an attachment, along the external surface of the inflatable structure, comprising:
providing the attachment including a plurality of strips comprising the first hook and loop fasteners and a plurality of connecting strips attached to each of the plurality of strips;
extending the attachment around a perimeter of an external surface of the inflatable structure wherein a length of the connecting strips is based on the perimeter; and
attaching a third hook and loop fastener at one end of the plurality of connecting strips with a third hook and loop fastener at an opposite end of the plurality of connecting strips after the extending step to secure the attachment along the external surface of the inflatable structure.
